(19) United States
(12) Patent Application Publication
(10) Pub. No.: US 2023/0264823 A1
(43) Pub. Date: Aug. 24, 2023

(54) Charging System for Aircraft and Drones

(71) Applicant: Elijah Abron, Silver Spring, MD (US)

(72) Inventor: Elijah Abron, Silver Spring, MD (US)

(73) Assignees: Teresa Abron, Silver Spring, MD (US); Elijah Abron, III, Silver Spring, MD (US)

(21) Appl. No.: 17/678,810

(22) Filed: Feb. 23, 2022

(51) Int. Cl. B64D 27/24; B64D 41/00

(52) U.S. Cl. CPC B64D 27/24; B64D 41/007; H02J 7/14

(57) ABSTRACT

An auxiliary charging system comprising of: a recovering system for capturing kinetic energy from a propeller exhausted air; and at least two sets of propellers, one set of propellers is located on the electric motor, and the other set of propellers is situated on an alternator or the generator unit is in this process; the alternator can be located in the front or behind of an aircraft electric motor or aircraft wing or vice versa (Anywhere on the aircraft) for recharging batteries and supplying power back to the propeller electric motor that is powering the aircraft; the propeller electric motor and the alternator propeller is a non-connected systems. The exhausted kinetic energy air from the alternator propeller captures kinetic energy air from the propeller electric motor; this kinetic energy adds motion to the propeller driveshaft of the alternator. The propellers are arranged to transform this oscillating motion energy from one propeller to the next, propeller producing regenerated air energy from the oscillating movement of the kinetic energy air body into a mechanical motion.

The present invention relates to generating electrical energy for the electric airplane or drone using the wasted kinetic energy from the propellers by capturing the exhausted kinetic energy air from the main propeller that is rotating the propeller blades and shaft, a secondary propeller blade that's connected to an alternator shaft (the two shafts are not connected), A propeller produces thrust through a momentum transfer from the propeller to the air by the rotation of the propeller blades. Momentum is the product of mass and velocity, and you can think of the torque generated as the reaction to the acceleration of a column of air with a diameter equal to that of the propeller.

### BACKGROUND

### Field of the Disclosure

The present disclosure generally relates to providing energy for an aircraft such as a drone or electric airplane to help power the craft, at least in part, by electricity storing the electricity in a batteries bank for consumption by motors to drive or power the vehicle or a portion thereof while the vehicle is in flight; today's drones an aircraft that are trying to be invented has such a short mileage range because the batteries do not allow them to travel any length of distance by solving this problem by using the wasted energy from the main electric motor propellers can help extend the charging ability and range of any drone, electric vehicle or electric aircraft, the captured energy is from the propeller, a byproduct of the main electrical motor, this auxiliary propeller that's connected to the alternator? capture the wasted kinetic energy air that's flows from the engine leading propellers that are propelling the aircraft, the kinetic energy air which is a byproduct of the leading electrical motor propellers or propellers.

### Description of the Related Art

This is a more desirable way and green way to have an alternative energy source that less expensive than adding more heavy batteries to achieve a longer flight time, also earning a more efficient cleaner output by obtaining power from wasted kinetic energy from an airflow, electric vehicles and aircraft vehicles derive locomotion power from electricity often received from an energy storage device within the vehicle. The energy storage device could be a battery, a batteries array, or energy storage and containment device. Hybrid electric vehicles include regenerative charging that is capturing energy from vehicle braking and traditional motor to charge the energy storage device and provide electricity to the vehicle.

### SUMMARY OF THE INVENTION

Various embodiments of the systems, methods, and devices within the scope of this appended claims each have several aspects. Without limiting the scope of the appended claims, the description below describes some prominent features.

According to one aspect of the present invention there is provided a constant speed of the propeller for feeding air powering to the alternator at a continuous output comprising: the motor propeller creating an airflow that's moving the air to a second propeller to rotate the alternator unit shaft and produce a voltage that is regulator by a controller that control the output voltage; and at least one or more propellers units that are in line with each other in two different locations.

According to another aspect of the present invention there is provided a fixed pitch propeller for generating power for aircraft such as drones or drone light aircraft comprising: at least a fixed-pitch propeller that is mounted behind each motor-powered propeller; this is a non-connected units, one being power and the other being connected to a propeller that is connected to a standalone alternator unit.

According to one aspect of the present invention there is provided a method of extracting power from the spinning motor driving propeller sets up a pressure that is lower than the air stream in front of the propeller and the higher airstream behind the propeller, causing the second propeller downstream to turn, the pressure eventually returns to free stream conditions with the force that is applied to the propeller alternator downstream, causing the propeller to turn and

start generating power, the exiting air causing a more incredible velocity than the free stream of air, which causes the propeller to turn the alternator; this working airflow creates electricity.

Embodiments of the invention provide significant advantages in helping with the energy problems of today. Drones and electric vehicles have some of the same disadvantage batteries life, decreasing flight time and travel time for drones, aircraft, and electric vehicles. The unit will generate electrical power in the air or on the ground; the charging unit may be large or small and portable. The power alternator is particularly useful in many different applications.

### SUMMARY OF THE INVENTION

The air charging alternator unit takes wasted air energy. It converts into electrical energy for use, the aerodynamic force from the rotor blades, which work like an airplane wing or helicopter rotor blade. When air flows across the blade, the air pressure on one side of the blade decreases. The difference in air pressure across the two sides of the blade creates both lift and drag.

### BRIEF DESCRIPTION OF DRAWINGS

For a better understanding of the present invention and to understand how the same may be brought into effect, and reference will now be made by way of example only to the following drawings in which:

FIG. 1 illustrates the power alternator according to one embodiment of the present invention; drone power layout for aircraft concept.

FIG. 2 illustrates the layout alternator components without a gearbox on the propeller shaft, with airflow.

FIG. 3 illustrates a power alternator comprising of a gearbox and connection to the propeller and alternator.

FIG. 4 illustrates air transfer from the propellers that generate power to the alternator according to one embodiment of the present invention;

FIG. 5 illustrates an airplane with propellers facing the back and front of the aircraft the variation of alternator connection without gearbox to the propeller shaft.

FIG. 6 illustrates shows two propellers mounted on one electric motor unit that is not connected.

FIG. 7 illustrates a dual charging alternator unit using dual propellers to generate electricity energy in series.

FIG. 8 illustrates showing the process layout on a drone aircraft unit;

### DETAILED DESCRIPTION OF THE INVENTION

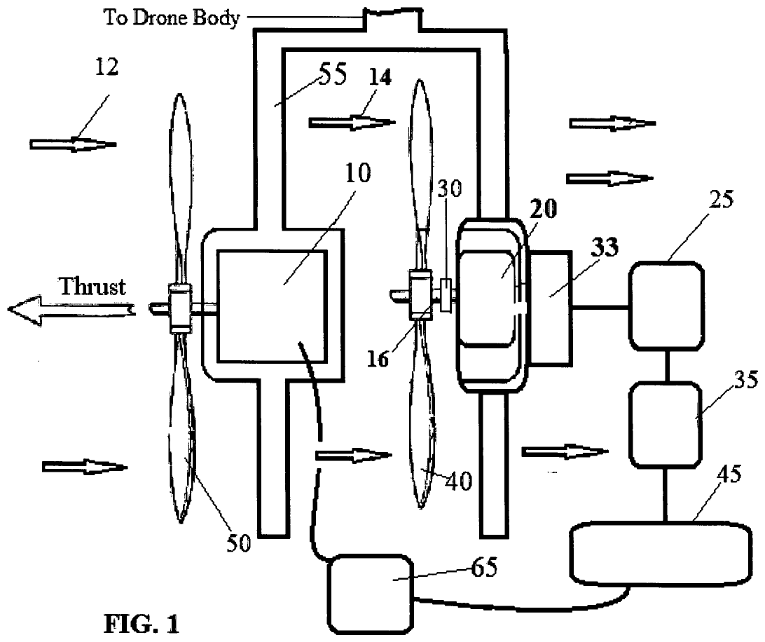

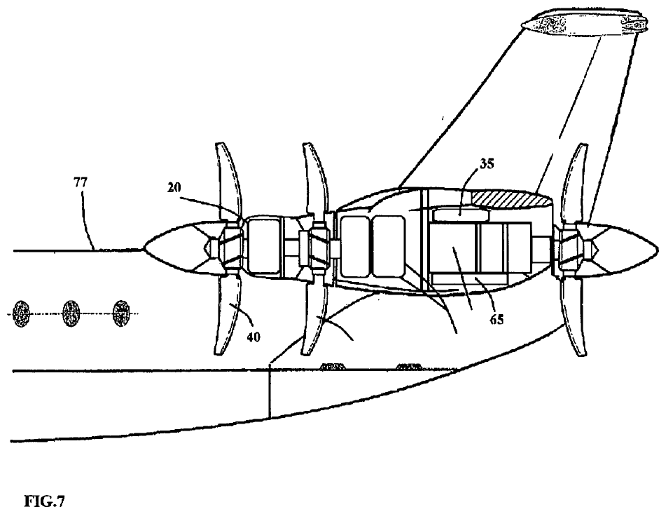

The air charging alternators unit works on a simple principle: The wasted exhaust air from the motor propeller exhausted air or the movement of the aircraft moving in the air, this air the air that the plane is moving aside. The aircraft 77 in FIG. 7 has a dual charging alternator and a configuration to be powered from back or the front of the electric motor to generate electricity energy. The air 2 flow forced into from the electric motor 10 propeller blades 50 that's rotating the propeller blades (As shown in FIG. 1) what's the low-pressure air passes thru the propeller blade, the pressure increases to a higher pressure than produced, this high air the force that makes contact with propeller 40, once the high-pressure air makes turns with the the propeller begins to turn the shaft that's connected to alternator 20 once the alternator reaches the correct RPM will start producing an electrical voltage output from the rotation.

The kinetic energy describes the process by which the kinetic energy is to generate mechanical power to create electricity. This mechanical power to recharge batteries 45 of drone air crafts, or for specific tasks such as electric, boat, drones, electric airplanes 77 or electric vehicles of all models can use this process to convert kinetic energy into electricity for recharging batteries.

Using the aerodynamic force from the rotor blades works the same as an airplane wing or a helicopter rotor blade. When air flows across the blade, the air pressure on one side of the blade Decreases the difference in air pressure across the two sides of the blade, creating both lift and drag. The force of the lift is stronger than the drag, and this causes the shaft to spin. The shaft is connected to the alternator 20, either directly (if it's a direct drive propeller on the alternator 20) or through a rod and a series of gears (such as gearbox 33) that speed up the rotation and allow for a physically smaller alternator 20. This translation of aerodynamic force to rotation of alternator 20 creates electricity.

The alternator 20 unit has a fixed pitch propeller 40 and the electric motor 10 and propeller 50 is not directly connected; if the voltage demand increase from the electric motor 10, the rpm will increase, and if the voltage demand decreases, then the rpm decreases and vice-versa. It is not necessary to monitor the rpm on the alternator 20-unit shaft because the two-propeller units are not connected; therefore, no Overspeed; the propeller shaft has a regenerative drive braking unit to reduce the speed, if necessary, a constant speed propeller unit has a governor that controls the braking unit on the driveshaft and automatically coarsens the propeller pitch to maintain the same rpm and prevent the alternator 20 over the output of the voltage during charging. A variable pitch propeller is one where the output voltage is a controlled to a set the point, and the controls of the blade angle automatically adjust during flight. This adjustment allows for an extensive range of power settings and propeller speeds, meaning that the most efficient operating setpoint is on the desired airspeed.

The variable pitch propellers can either be manually adjusted or mechanically governed to maintain a constant speed irrespective of the flight air condition. Since the propeller 50 on the electric motor 10 is directly connected, the rotation speed of the propeller 50 is a direct function of the electric motor 10 speeds. For this reason, the propeller 40 speed on the alternator 20 will vary with airspeed, altitude, aircraft 77 attitude, and motorized throttle setting. The angle that the blade makes with the relative wind will determine how much lift and drag (thrust and torque) is produced on the alternator 20 propellers. The resultant angle of attack is a function of both the rotational velocity of the blade as well as the forward airspeed of the electric motor 10 propeller 50.

The alternator 20 electrical energy harnesses from the air 12 is a clean, accessible, and widely available renewable energy source—to generate electric power for recharging batteries 45 while using the batteries 45 to operate other components in the aircraft 77 such as the light control system . . . , Output voltage 220 V, frequency 50/60 Hz, the shaft speed at 3600 rpm at speed are 60 miles an hour for the voltage of 220v AC (or a lower rpm speed using a PTO), the alternator 20 charges an electric vehicle battery at 11.5 kW an hour, meaning a 60-kWh battery needed about 6 hours to charge the battery fully. The charger voltage regulator regulars the voltage in the inverter127 also can be used to convert AC to three-phase current or DC on a twin the system with a dual AC unit with a connecting port 277 AC output.

The alternator 20 chargers 35 unit turns air energy into electricity using the aerodynamic force from the rotor blades; when air flows across the blade, the air pressure on one side of the blade decreases. The difference in air pressure across the two sides of the blade creates both lift and drag. The force of the lift is stronger than the drag, and this causes the rotor to spin. The rotor connects to the alternator 20, either directly (if it's a direct drive alternator 20) or through a shaft and a series of gears 33 (or transmission) that speed up or slow down the rotation and allow for a physically smaller alternator 20. This translation of aerodynamic force to the rotation of an alternator 20 creates electricity.

The alternator 20 in FIG. 1 is small and cylindrical 20 with an outer casing frame 55 is for mounting on smaller units like drones, mounting bracket for holding the alternator 20 and electric motor 10, and the propeller, there are many other the position and ways of to mount the unit depending on if it's a vehicle, aircraft, or drone.

As stated before, the force of the air is the energy that is needed to make the alternator rotate. Rotation can come from two different sources and power from another propeller or fan blade. Each separate force will eventually create a rotating force on the propeller 40 alternator 20.

In FIG. 1 the, air 12 is a low-pressure air applied to the propeller and transformed to a high air 14 pressure force spinning shaft 16 attached to the alternator 20 shafts. The the main job of the propeller is to absorb the energy and apply it to the alternator 20, and use it to create rotational motion.

As an aircraft 77 moves in the air from its electric motor10, rotating the propeller 50 and pulls in air 12 to creating thrust, as the propeller turns creating thrust the air 12 is moving at a faster pace applying pressure on propeller 40, causing the air 14 to have a higher air pressure and more rapid movement to be applied to alternator 20 shaft 16, causing the shaft to rotate faster, the rotation of the shaft 16 causes the inner workings of the alternator 20 to spin faster and start producing electricity. The propeller 40 on the alternator 20 rotates at a lesser speed than the propeller 50 on the electric motor 10 unit.

The current law of electromagnetism as the alternator 20 and shaft 16 starts turning to start the induction process in the wire winding inside the alternator housing; once the conductor starts creating movement through a magnetic field creates an electric current and the current strength is equal to the rate of change through the magnetic field. So, the faster the copper coil rotates, the more electricity.

The electricity that produced is being extracted from the alternator 20 and sent to the power inverter 25. The method of retrieving the electrical energy, once the alternator 20 is rotating and creating electrical power created by the movement of the propeller 40, and sent to the power inverter 25 once the inverter 25 is supplying power to the battery's charger unit, charging the batteries 45 also provides electrical power to the electric motor controller 65.

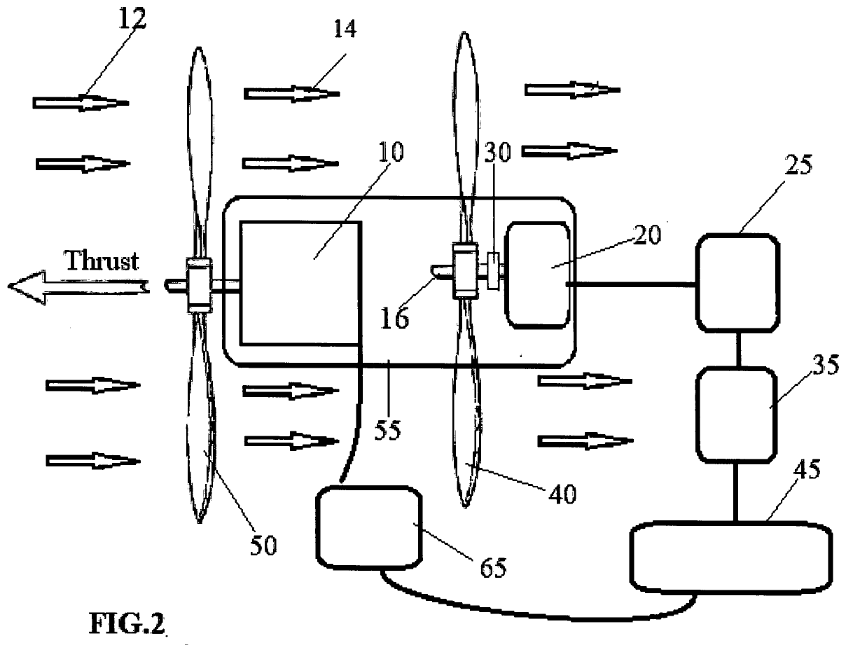

Note: in this particular case, we get electric energy produced clockwise or counterclockwise direction (the movement of air from a propeller or air from just the wind they both will be causing the shaft to spin), (In FIG. 2 shows that the system can supply power to a drone aircraft, the layout drawing item is a concept drawing of a drone frame 55 that can support the idea for connecting to a drone aircraft);

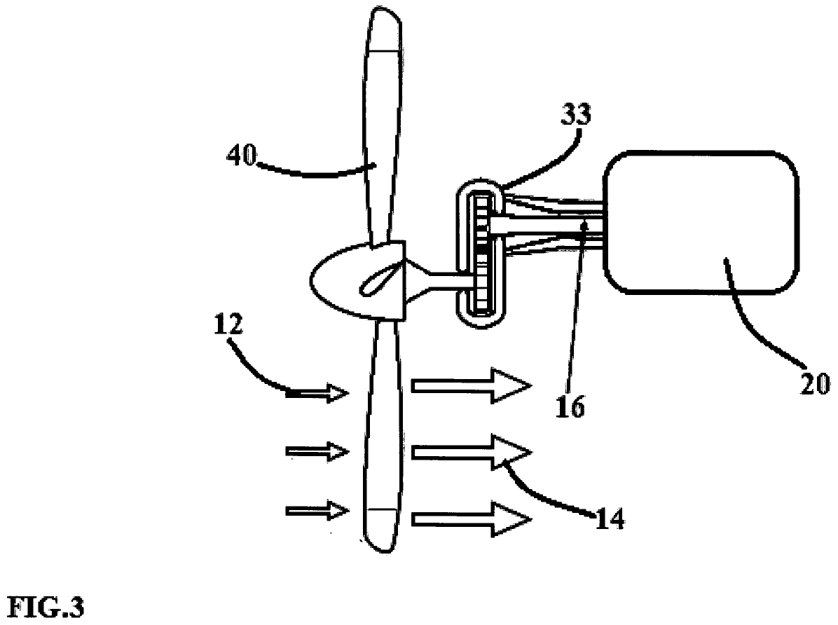

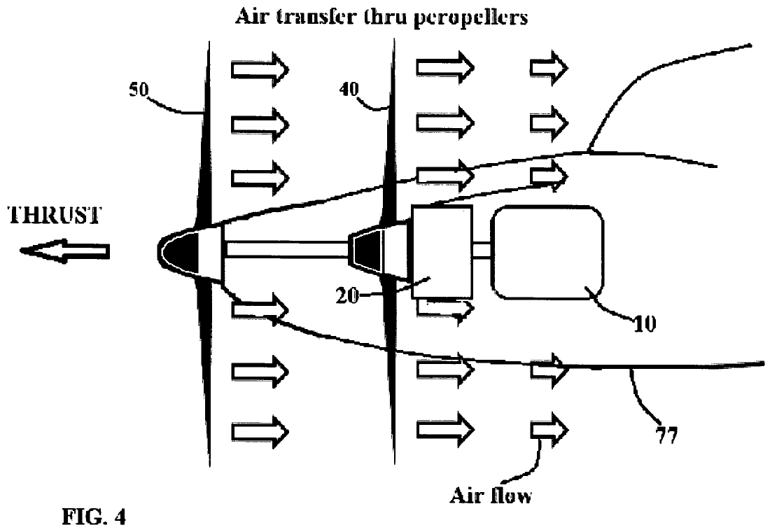

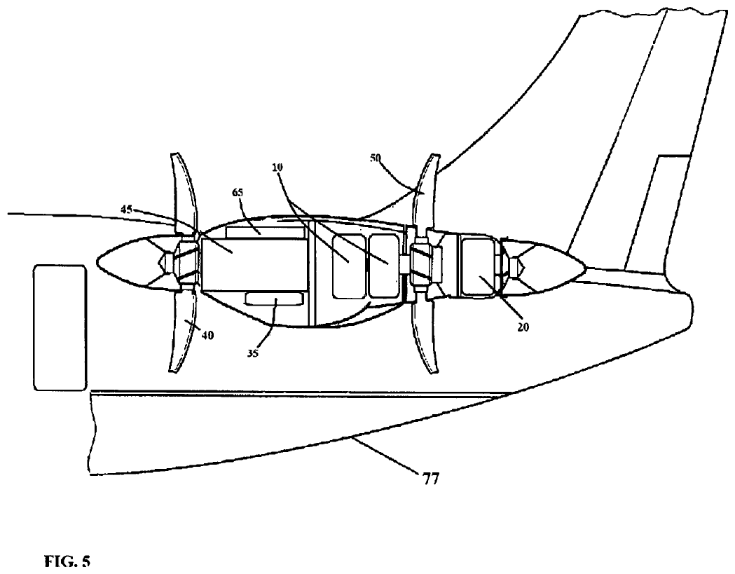

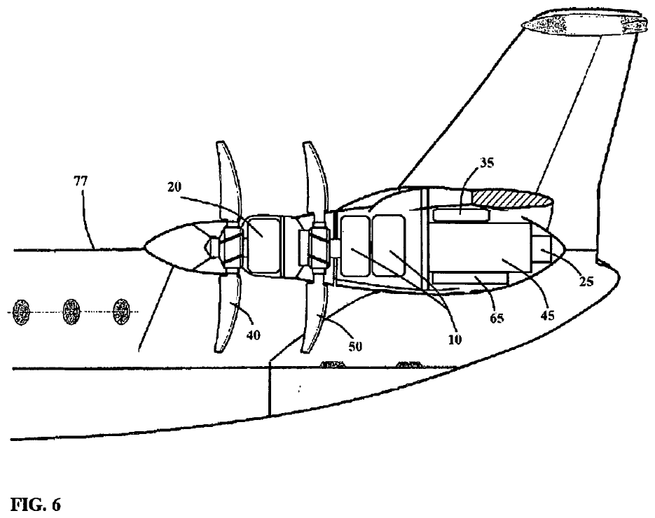

The operation of the airpower alternator can be understood by referring to FIG. 2, component layout. FIG. 3, is an illustration of a gearbox or a transmission for speed control, FIG. 4, is an illustration of the airflow between the prope11er50 and propeller 40, FIG. 5 as shown, the engine has a propeller both front and back of the engine, but the process remains the same. And FIG. 6, as shown in FIG. 6, two propellers are mounted on one engine that is not connected; the drive shaft is a lot longer than passes thru propeller 50. In the illustration, the rotation of the propeller 40 and 50 remains. The propeller 40 within a rotation is denoted using the process of the connecting drive shaft 16 attached to the alternator 20 and the propeller 40 by a driveshaft 16. The rotation of the drive shaft 16 provides control of the cycle generated by force from the air 4 that was generated from the electric motor 10 and propeller 50 rotational movement of the driveshaft 16 provides for power extraction to the alternator 20.

Running at its maximum displacement away from the propeller 40 and is tilted at an intermediate, the driveshaft 16, as shown in FIG. 3, is at a middle removal away from the propeller 40 and is tilted at a minimum angle. In this particular embodiment,

In other embodiments, the propeller blade angling controls the system for slowing down the speed of the propeller's 40 blades and driveshaft 16 to accommodate changes in airspeed. Also, a gearbox 33, as shown in FIG. 1, can change the rotational speed of the alternator output shaft.

In other embodiments, the propeller can provide adaptation to different weather conditions (with appropriate blade angle control unit) to give transformation to different air conditions.

In other embodiments, the constraining link may be extendible. In FIG. 1, the drive shaft 16 rotates from the propeller 40. allows the alternator to extract power from the rotation of the shaft in a clockwise or counterclockwise rotation. According to the current embodiment, the propeller 40 to the alternator from the air 12, to the alternator outside the cavity, which can extract power from a kinetic energy airflow from left to right. This process helps remove energy from a moving aircraft.

In one application of embodiments of the invention, the braking 30 unit is for stopping or locking the alternator propeller and keeping the air from moving them in a park position when A charging system is not needed.

In another application of embodiments of the invention, the alternator unit can recharge batteries 45; even if the vehicle is not moving, the wind will apply force against the propellers of the aircraft, 77 is sitting on the ground in the direction of the wind, the Propeller blades will start rotating and start charging the aircraft batteries.

In another application of embodiments of the invention, all gasoline or diesel automobiles, trucks, boats, and airplanes required an alternator for charging batteries 45, which is connected to the engine to create the electrical energy for recharging the batteries 45 and maintaining the power within the vehicle as the engine runs; the process requires a connection to the batteries 45.

Now how the same process relates to a drone? On the basic drone, there are 4 high-speed motors driving propellers (not shown) at tens of thousands of revolutions per minute (RPM). The power systems on these drones operate at voltages ranging from 4.2 volts (v) for the micro drones, to 25 v for the high-powered mini quads, the generator or alternator charging the system connected in parallel, series, or series-parallel circuits for voltage output; for an For example, two 12 volts generators in a series can produce 24 volts, and 3 generators in a Series 36 volts and four at 48 volts plus the amps double up when it's connected in series, the a process capable of charging multiple types of batteries in addition to the LiPo, the charging unit is also capable of charging lead-acid batteries like what is in your car or NiCad batteries for other uses. The control circuitry can adjust the voltage and charge rate, along with the total charge applied to a battery.

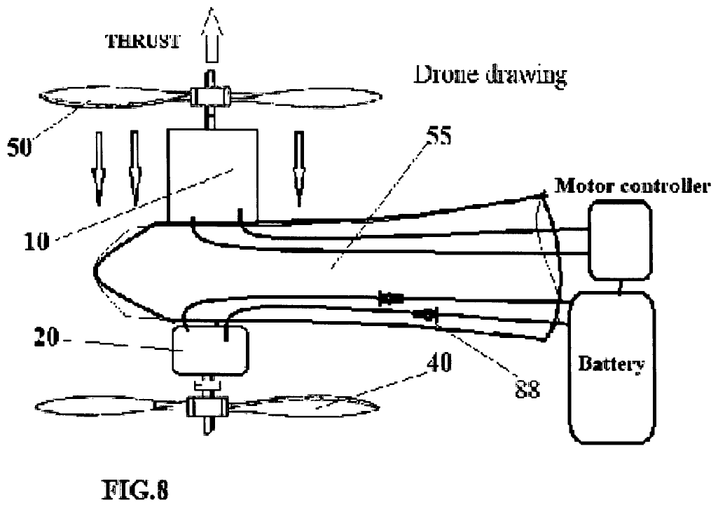

In the illustration (FIG. 8) showing the process layout on a drone unit; there is only one motor and one generator unit, but there are four total (more than one generator unit can be added) there are four propeller electric motors, 10 and four generators 20 charging units that help replenish voltage back to the batteries while the drone is in flight; this process helps extend the flight time in the air by sending power back to the batteries 45 and flying the drone at the same time the system adds some voltage back to your batteries 45 as the drone is in flight, there are diodes rectifier 88 that keeps Neg and pos flow in both directions from the generator thru the wires on positive wires and negative wires to save the current output power from feeding back to the generator 20 units; wire 84 provides power to electric motor 10, and wires 83 power wires feeding back to the battery.

The battery charging system can often utilize many sources of output power, levels of direct current (DC) provided by the generator unit; furthermore, the generator charging unit with the ability to utilize DC output which also has multiple levels of outcomes that allows charging and flying voltage ranging from low 3.7 or higher.

The invention herein involved, the intended that all of the subject matter of the above a description that is shown with the accompanying drawings shall be interpreted merely as a demonstration of the illustrating of the inventive concept herein and shall not be construed as limiting the nature of the invention.

What is claimed is:

1. An apparatus for air charging alternator comprising: a collective body of kinetic energy air that's is created by the rotation of the propellers that are on the electric motor; this pressure is transferring from the main propeller output to a secondary propeller, that's is, an alternator unit, the electric motor propellers that are powered by a bank of batteries, this propeller movement causes the alternator propellers to start rotating, and the high air pressure coming from the main motor propellers that are forcing a high volume of pressurized air on the alternator propellers, this high-pressure volume of wasted air energy is now an energy source that is reused, the alternator propellers, which are rotating and create electrical energy from this rotation; a power inverter for converting power from DC or AC; to send electrical power for charging lithium-ion batteries (Or other types of batteries), the batteries charging unit is arranged to transform the voltage back to the batteries and also supplies power back to the propeller the motor that's powering the propellers, a gearbox for changing RPM ratio; a voltage reducer; a Fixed Pitch propeller; a constant speed propeller; a regenerative braking unit; also, an alternator or alternator or both for supplying AC or DC output voltage; a self-recharging system for aircraft and drones, automobiles, boats, and ships, a motorized propeller unit and an alternator unit located in the front or back of the plane.

2. The apparatus of claiml wherein the motor propellers thrust pulls air behind the propellers blades causing movement to another fixed pitch propeller located behind the propeller

3. The apparatus of claim 2 wherein the motor propeller forward thrust pulling air behind the propellers causing movement to the constant speed propeller pitch that's connected to a alternator or generator.

4. The apparatus of claim 3, wherein the forward movement of the aircraft causes the propeller on the generator, unit to turn.

5. The apparatus of claim 4 wherein the propeller exhausts thrust kinetic energy air to create electrical energy.

6. The apparatus of claim 5 wherein the power inverter for controlling the type of output voltage AC or DC.

7. The apparatus of claim 6 wherein the controls of the propellers are arranged by controlling the the pitch of the propeller to control the speed of the alternator/generator.

8. The apparatus of claim 7 wherein the propeller generating station comprises of a a propeller that is unattached unconnected from the electric propeller motor, and is arranged to move independently.

9. The apparatus of claim 8 wherein the alternator propellers are arranged to collect the kinetic energy from the thrust of moving air from the motor propeller and apply this energy to create rotation on the generator propellers.

10. The apparatus of claim 9 wherein the generators' units can be connected in series, parallel, or series-parallel for different voltage output levels.

11. The apparatus of claim 10 wherein the motor propeller moves in a forward thrust direction pulling air behind itself with the first propeller moving faster than the second the propeller that's in a different location.

12. The apparatus of claim 11 wherein the propeller alternators/generator's unit can be mounted anywhere on an aircraft or vehicle, external or internal.

13. The apparatus of claim 12 wherein a power inverter for changing from DC to AC the voltage;

14. The apparatus of claim 13 wherein a propeller that rotates when in contact with energy from the wind creates rotation that turns the shaft on the generators.

15. The apparatus of claim 14 wherein the propeller speed control unit is arranged in a manner to control the propellers blades pitch angle of the blade while the aircraft is moving.

16. The apparatus of claim 15 wherein the secondary air charging system consists of at least one or more propeller generators unit in series for higher voltages and amps output.

17. The apparatus of claim 16 wherein the driveshaft regenerative braking system can control the speed of the propeller to stop it from overrunning.

18. The apparatus of claim 17 wherein the alternator comprises a gearbox or transmission for increasing or decreasing the RPMs of the propeller.

19. The apparatus of claim 18 wherein the secondary air charging system consists of at least one or more propellers for driving the alternator or generator unit.

20. The apparatus of claim 19, wherein the aircraft comprises a commercial vehicle or non-a commercial vehicle that travels in the air or on the ground, or in water,
